(19) United States
(12) Patent Application Publication
(10) Pub. No.: US 2026/0149708 A1
(43) Pub. Date: May 28, 2026

(54) Enabling a Validation Agent to Initiate an Automated Validation Procedure

(71) Applicant: DigiCert, Inc., Lehi, UT (US)

(72) Inventors: Ayne Lyons, Seattle, WA (US); Flavio Martins, Seattle, WA (US); Aditya Chandel, Lehi, UT (US); Vadym Merzlikin, Pleasant Grove, UT (US)

(73) Assignee: DigiCert, Inc., Lehi, UT (US)

(21) Appl. No.: 18/956,347

(22) Filed: Nov. 22, 2024

(51) Int. Cl. H04L 9/40

(52) U.S. Cl. CPC H04L 63/0823; H04L 63/20

(57) ABSTRACT

Systems and methods are provided for validating client information prior to certificate issuance. A method, according to one implementation, includes a step of providing an initiation option to a validation agent in response to the validation agent selecting a portion of a document retrieved from a reliable web source, the initiation option allowing the validation agent to initiate an automated validation procedure. In response to the validation agent selecting the initiation option, the method includes a step of performing the automated validation procedure, wherein the automated validation procedure includes a) a comparing sub-step in which the portion of the document selected by the validation agent is compared with client information included in a certificate request, and b) a compliance sub-step in which it is determined whether or not a comparison, based on the comparing sub-step, complies with a validation guideline.

### FIELD OF THE DISCLOSURE

The present disclosure generally relates to trust entities configured to generate digital certificates. More particularly, the present disclosure relates to systems and methods for validating client information in response to receiving requests for digital certificates.

### BACKGROUND

In the context of digital certificates, a Certificate Authority (CA) initially performs a validation process to validate that the requesting client is who they say they are. For instance, a validation agent employed by the CA will historically utilize many manual processes for confirming or verifying this client information. Once this information is validated, the CA may proceed with the certification process for issuing a digital certificate for the client. Using conventional steps in the validation process, a validation agent may browse various websites (e.g., usually approved by the CA) to gather relevant information. In some cases, the validation agent may capture images of webpages, which can be used at a later time for determining if the information submitted by the client matches official records on the web. However, at times, the conventional processes can lend themselves to human errors by the clients and/or the validation agents, such as typographical errors, misreading or misunderstanding information within a web source, misunderstanding industry requirements, and/or using out-of-date web sources. These mistakes can lead to improper issuance of a certificate, which can put the CA out of compliance with validation guidelines.

### BRIEF SUMMARY

The present disclosure relates to systems, methods, and tools for performing validation procedures. According to a first general operation, a first method is configured to determine a validation status of an organization. The first method includes a step of obtaining enrollment information submitted from an organization to a trust entity, wherein the enrollment information includes details of the organization. In response to a web browser of the trust entity being navigated to a webpage associated with the organization, the method further includes a step of extracting identifying data from the webpage. Based on a comparison between the identifying data and the details of the organization, the method also includes providing feedback to a validation agent of the trust entity regarding a validation status of the organization.

According to some embodiments of this first method, the steps of extracting the identifying data, making a comparison, and providing the feedback may be automated actions involving Artificial Intelligence (AI) operations. The AI operations, for example, may further include actions of automatically navigating the web browser to the webpage, automatically converting the webpage to a string, and automatically extracting the identifying data from the string. The web browser, in some cases, may be associated with the validation agent, where the step of extracting the identifying data from the webpage may be initiated in response to receiving a specific capturing instruction from the validation agent. The details of the organization may include organization name, organization address, trade registration number, trade registration status, and/or trade registration date.

In response to the web browser being navigated to multiple webpages associated with the organization, this first method may further include a step of extracting multiple sets of identifying data from the multiple webpages. The multiple webpages may be selected from a list of approved web resources where the identifying data can be collected. The list of approved web resources may include government websites, Secretary of State websites, government trade registry databases, trade registration websites, organization registry websites, institution websites, and/or banking websites. Furthermore, in response to detecting that the multiple webpages use different naming conventions for the multiple sets of identifying data, the method may further include a step of performing an interpretation procedure to remove ambiguity with respect to the different naming conventions.

In some embodiments of the first method, the step of extracting identifying data from the webpage may include a) capturing a screenshot of the webpage, and b) performing an optical character recognition procedure to collect the identifying data. When the comparison between the identifying data and the details of the organization results in a match, the method may further include a) setting the validation status to confirm that the organization is valid, b) providing feedback to the validation agent that the organization is valid, and c) in response to the validation agent verifying the validation status, forwarding a Certificate Signing Request (CSR) to a Root Certificate Authority (Root CA) or Intermediate CA (ICA) associated with the trust entity for requesting a digital certificate for the organization. In some embodiments, when the comparison between the identifying data and the details of the organization does not result in a match, the method may include the steps of a) setting the validation status to invalid, and b) providing feedback to the validation agent explaining discrepancies in the comparison, whereby the discrepancies may include missing information, additional fields needed, misspellings, mistyping or entry errors, incorrect webpage, incorrect section of the webpage, incorrect enrollment information, and/or incorrect organization information.

In response to the browser being navigated to a webpage written in a language different from a base language, the first method, according to some embodiments, may further include a step of automatically translating the webpage to the base language. The enrollment information, for example, may further include a type of validation to be performed for the organization, the types of validation selected from Domain Validation (DV), Organization Validation (OV), and Extended Validation (EV). The type of validation, for instance, may define a number of fields and types of fields to which the extracted identifying data is to be assigned. In some embodiments, the method may further include a step of categorizing the identifying data into the fields based on a URL of the webpage.

According to a second general operation, a second method is associated with a validation tool. For example, the validation tool may be configured to be executed by a validation agent for validating information associated with a client (e.g., organization). The validation tool may be part of the validation program and may include logic code, software, firmware, or the like, and may be stored on a non-transitory computer-readable medium. As such, the logic code may include instructions or commands that enable or cause a processing system to perform certain functionality for validating information regarding the identity of the client.

The second method, in particular, includes a step of displaying client information submitted by a client on a home screen of a user interface being operated by a validation agent responsible for executing a validation job for the client. Also, the method includes a step of displaying a validation sources tab on the home screen. In response to a selection of the validation sources tab, the method further includes a step of displaying links to vetted web sources from which data can be obtained to assist the validation agent with executing the validation job.

Prior to displaying the links to the vetted web sources, the second method may further include a step of performing a vetting procedure to pre-select a list of reliable websites that are applicable for execution of the validation job for the client. For example, the reliable websites may be identified by Uniform Resource Locator (URL) information or Fully Qualified Domain Name (FQDN) information. In some embodiments, the method may further include periodically updating the vetting procedure, which may include a) retrieving up-to-date knowledge of industry standards, protocols, and guidelines, b) adding any reliable websites to the list based on changes to the industry standards, protocols, and guidelines and/or changes to the reliable websites themselves, c) deleting any unreliable websites from the list based on changes to the industry standards, protocols, and guidelines, changes to the unreliable websites, and/or information regarding the unreliable websites being added to a government restricted list, trade embargo list, terrorism list, fraud list, or spam list, and d) identifying an updated list of websites by their URL and FQDN information.

According to some implementations, the second method may further include a step of displaying a checklist on the home screen, where the checklist may include validation items to be verified for the client to complete the validation job. The checklist, for example, may include a specific number and category of validation items based on a type of validation job being performed. That is, the type of validation job may include Domain Validation (DV), Organization Validation (OV), or Extended Validation (EV). Upon determining that evidence obtained from one of the vetted web sources positively verifies an identified validation item of the validation items, the method may further include marking the identified validation item in the checklist with a visual indicator (e.g., checkmark) to express completion of the identified validation item.

In response to a selection of one of the links to obtain data from a specific vetted web source, the second method, in some embodiments, may include the steps of a) navigating a web browser associated with the validation agent to a webpage of the specific vetted web source for displaying data associated with the client, where the data includes evidence that verifies identifying information about the client, and b) displaying an overlay panel over a portion of the webpage. The overlay panel, according to some embodiments, may include at least a highlighting toggle switch, wherein, in response to the highlighting toggle switch being turned on, the method may include highlighting the evidence on the webpage. The overlay panel, for instance, may include at least a page capture button, wherein, in response to the page capture button being pressed, the method 140 may include a) capturing an image of the webpage, and b) uploading the image to a storage device associated with the validation tool, wherein the image may be configured to be submitted as evidence for completing the validation job. The overlay panel, in some cases, may include at least a page capture button, wherein, in response to the page capture button being pressed, the method 140 may include obtaining the evidence using a Document Object Model (DOM) or obtaining the evidence as an HTML version of the webpage.

The second method, in some embodiments, may also include comparing the client information with the data obtained from one or more of the vetted web sources to detect typographical errors and/or other data entry mistakes. The client information, for example, may include at least name, address, contact data, and validation request data. For example, the client may be an organization, an individual user, or a network device, and the validation agent may be an employee of a trust entity. Upon the validation agent completing the validation job, the method may further include forwarding a certificate request to a Root Certificate Authority (Root CA) or Intermediate CA (ICA) of the trust entity for creating a digital certificate for the client. The certificate request may be submitted by the client to the trust entity along with the client information. The validation tool may enable the validation agent to execute multiple validation jobs for multiple clients simultaneously. Also, the method may include a step of selecting the vetted web sources from a plurality of reliable web sources based on a jurisdiction in which the client operates.

According to a third general operation, a third method includes a step of providing an initiation option to a validation agent in response to the validation agent selecting a portion of a document retrieved from a reliable web source, the initiation option allowing the validation agent to initiate an automated validation procedure. In response to the validation agent selecting the initiation option, performing the automated validation procedure, wherein the automated validation procedure includes a) a comparing sub-step in which the portion of the document selected by the validation agent is compared with client information included in a certificate request, and b) a compliance sub-step in which it is determined whether or not a comparison, based on the comparing sub-step, complies with a validation guideline.

The third method, according to some embodiments, may also include a step of presenting the portion of the document in a preview window of a User Interface (UI), wherein the initiation option is provided to the validation agent in response to the validation agent right-clicking on the portion of the document or inside the preview window. For example, it is determined that the comparison complies with the validation guideline when a string literal of the portion of the document is an exact match with a string literal of the client information. The method may also include steps of 1) obtaining an annotation from the validation agent, the annotation related to an execution of the automated validation procedure, and 2) adding the annotation to one of a) a digital certificate issued in response to the certificate request and b) a file associated with the execution of the automated validation procedure.

This third method may also include a step of providing an output in a User Interface (UI) associated with the validation agent, where the output may be related to results of the compliance sub-step. The method may further include a step of highlighting the portion of the document in an affirmative manner when it is determined that the comparison complies with the validation guideline. Also, the method may include a step of indicating non-compliance when it is determined that the comparison does not comply with the validation guideline. The method may also include a step of providing resolution options including one or more of a) automatically conforming the client information to the portion of the document, b) automatically conforming the portion of the document to the client information, and c) allowing the validation agent to manually change the client information. This method can further include a step of repeating the automated validation procedure in response to the validation agent selecting one of the resolution options.

The automated validation procedure, for example, may further include a qualifying sub-step in which it is determined whether or not the document qualifies as valid evidence with respect to the validation guideline. Prior to the validation agent selecting the portion of the document, the third method may allow the validation agent to upload the document from the reliable web source selected from a list of vetted web sources. The validation guideline, for instance, may be one of a plurality of baseline requirements established by the Certificate Authority Browser Forum. The third method may also include steps of a) providing a second initiation option to the validation agent in response to the validation agent selecting a second portion of the document, and b) in response to the validation agent selecting the second initiation option, performing the automated validation procedure for the second portion of the document with respect to a second validation guideline.

According to various embodiments of the three general operations described herein, the present disclosure may include a) methods having the above-mentioned steps, b) processing devices configured to implement the above-mentioned steps, c) cloud services configured to implement the above-mentioned steps, and/or d) non-transitory computer-readable media storing instructions for programming one or more processors to execute the above-mentioned steps.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a diagram illustrating a validation system according to various embodiments.

FIG. 2 is a diagram illustrating details of the trust entity shown in FIG. 1, according to various embodiments.

FIG. 3 is a block diagram illustrating a computing system of one of the components of the trust entity shown in FIG. 2, according to various embodiments.

FIG. 4 is a flow diagram illustrating a first general method for determining a validation status of an organization, according to various embodiments.

FIGS. 5-10 are screenshots illustrating a user interface associated with a validation tool for enabling a validation agent to perform a validation job of validating the identity of a client, according to various embodiments.

FIG. 11 is a flow diagram illustrating a second general method associated with a validation tool for allowing a validation agent to perform a validation job for a client, according to various embodiments.

FIG. 12 is a screenshot illustrating a user interface associated with a validation agent for enabling the validation agent to initiate an automated validation procedure, according to various embodiments.

FIG. 13A is a portion of the screenshot of FIG. 12 showing a selection option for the validation agent, according to various embodiments.

FIG. 13B illustrates the screenshot of FIG. 13A in which the validation agent right-clicks on the selection to reveal an auto-validate option, according to various embodiments.

FIG. 13C is a pop-up window illustrating a result of a comparison sub-step in which the selection of FIG. 13A does not match client submitted information, according to various embodiments.

FIG. 14 is a screenshot showing a result of the comparison sub-step in which the select matches the client information in compliance with a specific validation guideline, according to various embodiments.

FIG. 15 is a flow diagram illustrating a third general method for enabling a validation agent to initiate an automated validation procedure, according to various embodiments.

### DETAILED DESCRIPTION

Again, the present disclosure relates to various systems, methods, cloud-based services, software tools, workbench applications, etc. for enabling a validation agent to conduct validation services for a client, customer, organization, enterprise, etc. Using official web resources to gather evidence for validation, the validation agent can upload reliable documents having information that can be used for checking the validity of client data entered during submission of a certificate request. Highlighting features are used to highlight specific information within the documents, which can thereby be used for comparing the official or reliable information with entered client data. Manual or automated comparisons can be made to determine if the client data complies with industry standards, which in some cases may be referred to as “validation guidelines” or “baseline requirements.” The systems and methods described in the present disclosure are configured to assist the validation agent with their execution of validation jobs for validating client data. In some cases, the validation agent may initiate an automated validation process using a simple right-click operation in a User Interface (UI).

### Validation System

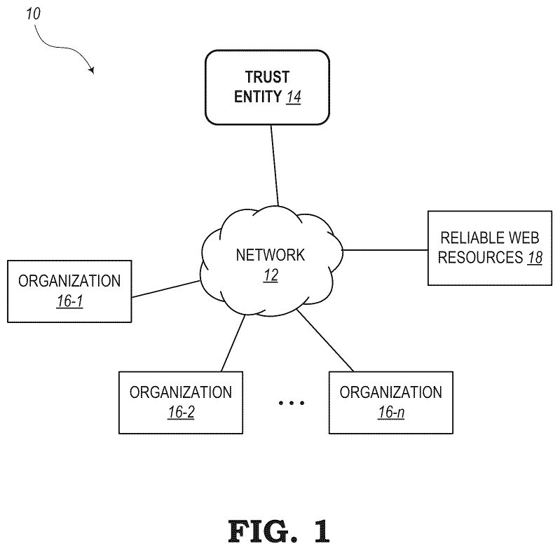

FIG. 1 is a diagram illustrating an embodiment of a validation system 10, shown in a simplified form. The validation system 10 is arranged over a network 12 (e.g., the Internet) and therefore may be configured to offer cloud-based services in a server/client arrangement. A trust entity 14 (e.g., Certificate Authority (CA), trusted third party, etc.), such as DigiCert, is configured to provide various services to organizations 16-1, 16-2, . . . , 16-n, clients, customers, enterprises, businesses, domains, individuals, etc. For example, the trust entity 14 may be configured to create, sign, and issue digital certificates to the organizations 16 in a Public Key Infrastructure (PKI).

For example, digital certificates as described herein may be X.509 certificates, as defined by the International Telecommunication Union (ITU) standard X.509, such as X.509 Information technology—Open Systems Interconnection—The Directory: Public-key and attribute certificate frameworks, October 2019, the contents of which are incorporated by reference in their entirety. An X.509 certificate binds an identity to a public key using a digital signature. A certificate contains an identity (e.g., a hostname, an organization, an individual, etc.) and a public key (e.g., RSA, DSA, ECDSA, ed25519, etc.), and is signed by a certificate authority. Standard X.509 also defines Certificate Revocation Lists (CRLs), which are a means to distribute information about certificates that have been deemed invalid by a signing authority, as well as a certification path validation algorithm, which allows for certificates to be signed by intermediate CA certificates, which are, in turn, signed by other certificates, eventually reaching a trust anchor or root. When a certificate is signed by a trusted certificate authority, or validated by other means, someone holding that certificate can use the public key it contains to validate documents or content digitally signed by the corresponding private key.

In an embodiment, an X.509 certificate can be used to digitally sign content. A content signing certificate allows individuals, teams, and organizations to add an electronic, digital signature to a document or other content in a variety of file formats to prove ownership. The digital signature is an encrypted hash of “your message” that can only be decrypted by someone who has a copy of “your public key,” which ensures (1) content stays unaltered, (2) the creator's identity is confirmed, and the like.

A digital signature cryptographically binds a digital signature certificate, issued by a Trust Services Provider (TSP), such as the trust entity 14, to a document using PKI technology. Digital signatures validate and authenticate signer identity and document integrity, delivering higher levels of assurance that the signer is who they say they are and that the document hasn't been altered. Digital signatures are ideal for transactions that require higher level of security and are necessary in certain countries and regions where companies are required to comply with legal regulations. In some countries, some forms of digital signatures have legal validity equivalent to handwritten signatures.

In another embodiment, the X.509 certificate can be referred to as a personal certificate. That is, it does not necessarily need to be used to digitally sign content. In a further embodiment, the X.509 certificate can be a content credential that includes history and identity data attached to content. A user can view this data when a creator or producer has attached it to content to understand more about what has been done to it, where it has been, and who is responsible. Content credentials are public and tamper-evident, and can include info like edits and activity, assets used, identity info, and more.

During an enrollment stage in which an organization 16 wishes to obtain a certificate, the organization 16 may submit an enrollment request, certificate request, or Certificate Signing Request (CSR) to the trust entity 14. Before proceeding to a certificate creation stage, though, the trust entity 14 may perform any suitable type of validation services for ensuring validity of the organization 16, authorized representative of the organization, and/or user device employed at the organization 16. These validation services may include research by employees of the trust entity 14 to confirm that the organization 16 is who they say they are and that the representatives are also who they say they are. This research, for example, may include dependence on various reliable web resources 18 and/or other sources and methods. The reliable web resources 18, for instance, may include government websites (e.g., Secretary of State websites, etc.), trade registry websites and databases, and the like. Thus, the employees can use these and other resources to confirm the validity of the organization 16 as well as people and equipment associated with the organization 16.

### Trust Entity

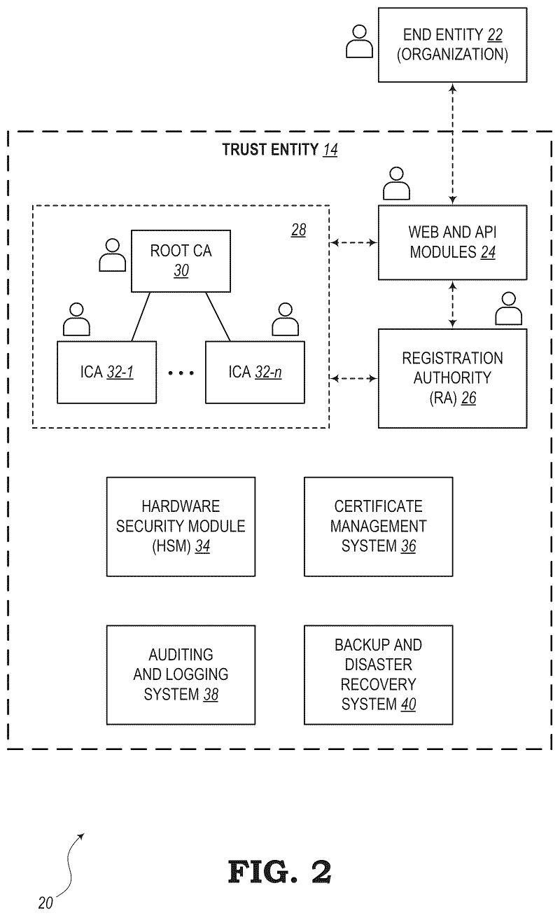

FIG. 2 is a diagram illustrating an embodiment of a request system 20 for handling certificate requests, validation, and the like. Furthermore, FIG. 2 shows an embodiment of the trust entity 14 in detail according to various embodiments. In the request system 20, an end entity 22 (e.g., an organization 16) is configured to request certification services from the trust entity 14. In this embodiments, the trust entity 14 includes web and Application Programming Interface (API) modules 24 configured to provide a secure interface or portal with the end entity 22. The trust entity 14 further includes a Registration Authority (RA) 26, a certification system 28 that includes a Root Certificate Authority (Root CA) 30 and one or more Intermediate CAs (ICAs) 32-1, . . . , 32-n. Additionally, the trust entity 14 may include a Hardware Security Module (HSM) 34, a certificate management system 36, an auditing and logging system 38, and a backup and disaster recovery system 40. According to other embodiments, the trust entity 14 may include other systems for providing other validation and certification services to clients. Various groups or teams of people may be employed by the trust entity 14 for performing certain tasks. These people may use computers, or the like, for performing research, validating clients, issuing certificates, etc.

The certification system 28 (normally referred to as a CA) is responsible for issuing, revoking, and managing digital certificates, which are used to authenticate the identity of the end entities (e.g., organization, companies, websites, companies, users, etc.) and establish secure, encrypted communications. The internal architecture of the certification system 28 may be designed to ensure security, scalability, and compliance with various standards (e.g., WebTrust, ETSI, etc.).

The Root CA 30 of the certification system 28 is at the top of the trust hierarchy and issues certificates to the ICAs 32 or directly to the end entity 22 in some cases. Typically, the Root CA 30 is kept offline and used sparingly to minimize exposure to security risks. Certificates issued by the Root CA 30 are trusted globally by browsers and operating systems. Personnel of the trust entity 14 may include an authorized staff at the Root CA 30 with strict controls and multi-factor authentication for gaining access to the Root CA 30.

The ICAs 32 are configured to issue certificates by the Root CA 30 and are responsible for issuing certificates to the end entity 22. The ICAs 32 are typically online, although their security is still intensely guarded. Multiple ICAs 32, as shown, can be used to create different classes of certificates (e.g., for SSL, code signing, etc.). Personnel stationed at the ICAs 32 may include security administrators who can oversee the operations of the trust entity 14. Again, proper access controls are enforced at this portion of the trust entity 14.

The web and API modules 24 include an interface that allows the end entity 22 to apply for certificates (e.g., provide certificate requests, submit CSRs, etc.), check certificate status, perform rudimentary validation tasks, perform certificate revocations, etc. The web and API modules 24 provide a secure portal for users to request, renew, and revoke certificates. The API allows integration with external systems, such as enterprise IT environments or DevOps pipelines, for automated certificate management. System administrators, customer support, validation agents, and IT staff may be employed for operating in this section of the trust entity 14. They may be involved with maintaining and securing the interface.

Validation agents may be employed for operating at the web and API modules 24 and/or at the RA 26. The RA 26 may be responsible for validating the identity of entities requesting certificates and can work closely with the certification system 28, but may alternatively operate as a separate entity or department. The validation agents may be configured to verify the authenticity of the information provided in certificate requests. Furthermore, they may be configured to ensure that the requestor has the correct ownership or control of the domain or asset to be certified. The job of the validation agents may also involve manual checks, automated verification (e.g., domain validation), among other tasks. The validation agents and other personnel of the web and API modules 24 and RA 26 may often be the first point of contact for certificate applicants and therefore may be trained in identifying fraudulent applications. The various embodiments described herein are primarily focused on the operations of the validation agents employed at these locations within the trust entity 14.

In addition to the validation and certification processes, the trust entity 14 further includes the HSM 34. One role of the HSM 34 is to offer a physical device that can be used to generate, store, and manage cryptographic keys to thereby ensure that the private keys of the trust entity 14 (e.g., CA) are not exposed. That is, the HSM 34 ensures that the private keys never leave the certification system 28 in an unencrypted form. The HSM 34 may also perform cryptographic operations, like signing certificates, within a secure environment.

The certificate management system 36 is configured to handle the entire lifecycle of certificates (i.e., issuance, renewal, revocation, etc.). Regarding certificate signing, the certificate management system 36 may be configured, once an application is approved, to generate the digital certificates, which can then be signed by the CA's private key. Regarding CRLs and the Online Certificate Status Protocol (OCSP), the certificate management system 36 may be responsible for maintaining the status of certificates (whether they are valid, expired, or revoked). The certificate management system 36 may also be configured to conduct key management functionality, whereby a secure key management system may be used for protecting the CA's private keys. The HSM 34 may also be used to securely store private keys. Personnel, such as highly trusted cryptographic officers and key custodians, are configured to operate with the certificate management system 36 and handle key material and certificate signing.

The auditing and logging system 38 may be configured to maintain detailed logs and audit trails for all certificate-related activities, ensuring accountability and compliance with legal and regulatory frameworks. It is configured to log all certificate requests, issuances, renewals, revocations, and other key operations. Also, it can regularly review audit logs and keep them for a certain period to comply with regulations. Logging, for instance, helps in the detection of anomalies or potential breaches.

The backup and disaster recovery system 40 may be configured to ensure continuous availability of CA services. This component is typically set up with redundancies, backups, and a disaster recovery plan. It is configured for regular backups of certificates, CRLs, and keys. Also, it may also be configured as a standby system for critical components, like the ICAs 32 and certificate management system 36 to switch over in case of failure.

### Workflow and Security

A requestor associated with the end entity 22 requests a certificate from the trust entity 14 (or CA) through the RA 26. This may include filling in enrollment applications, which may include entry of client data, such as organization name, address, phone number of email of a contact person, and other information typically needed for performing any suitable type of validation (e.g., Domain Validation (DV), Organization Validation (OV), Extended Validation (EV), etc.) and any type of certification generation.

The RA 26 is configured to verify the identity of the requestor (domain ownership, business authenticity, etc.). Again, this may be performed by a validation agent or validation expert employed for performing validation jobs on behalf of the clients, customers, requestors, etc. Once approved, the request is sent to the certification system 28 (or CA) for signing. As issuance, the certificate is generated and signed by the ICA 32 using the HSM 34. Next, the certificate is distributed to the end entity, and the CA publishes the certificate and its status to its repository. If a certificate needs to be revoked (e.g., when it expires), it is added to the CRL or handled through OCSP.

Again, a validation agent in the trust entity 14 or other CA environment is configured to play a key role in verifying the information provided by the end entity 22 (such as a domain owner, organization, or individual) before issuing a digital certificate. They are responsible for ensuring that the certificate requestor has legitimate control over the domain or organization for which they are requesting the certificate. Their duties and responsibilities vary depending on the type of certificate being issued (i.e., DV, OV, or EV).

In addition, the validation agent may utilize various software tools that can assist him or her with their validation jobs. With respect to DV, the validation agent may verify that the requestor controls the domain for which the certificate is requested, check ownership or control of the domain by validating DNS records or verifying through email sent to domain-associated addresses, and perform automated checks and/or might review exceptions or edge cases manually. It should also be noted that the validation agents are configured to oversee the process and may be obligated, according to various standards, protocol, requirements, guidelines, etc., to perform at least some level of human interaction or double checking, backup checking, to ensure that automated practices are reviewed and verified based on common sense, particularly when automatic validations fail or need manual intervention.

Regarding OV, validation agents may confirm the legitimacy of the organization requesting the certificate in addition to domain control. They may verify the legal existence and registration of the organization, validate the requestor's authority to request a certificate on behalf of the organization, and check business directories (like Dun & Bradstreet) or government databases to confirm the organization's details. This may include more manual processes in some cases as compared to DV, as the validation agent is responsible for performing multiple checks to confirm the organization's identity and legitimacy.

For EV, the validation agents are configured to perform the most rigorous validation process for high-assurance certificates, such as those used by financial institutions. The tasks of the validation agents may include verifying the organization's legal, physical, and operational existence, ensuring that the entity requesting the certificate has exclusive rights to use the domain, obtaining signed documents from an authorized individual within the organization, and performing in-depth checks of the organization's business information, including its registration, address, and other publicly available records.

Regarding organization and domain management for larger organizations, the trust entity 14 may issue many certificates for their multiple businesses and websites. This can keep the organization and domain information up-to-date so they can continue to get new and renewed certificates promptly.

However, before the trust entity 14 (e.g., DigiCert) can issue any type of certificate, the certificate order must go through a validation process. For OV and EV TLS/SSL, Private SSL, Code Signing, and Document Signing certificate orders, the certificate's validation process includes organization validation and verifying the organization contact. For certificates that are issued to a domain (e.g., TLS/SSL, client certificates, etc.), the certificate order process includes domain validation. To quicken the certificate issuance process, the end entity 22 may want to submit their organizations and domains for pre-validation. Once they have completed pre-validation, future certificate issuance and renewals for those domains and organizations can be done promptly.

Regarding OV to validate an organization, the trust entity 14 may first verify that the organization requesting a certificate is in good standing. This includes confirming good standing and active registration in corporate registries. Information regarding the standing of an organization and/or its proper registration, the validation agent may consult with one or more of the reliable web resources 18. Verifying a standing criteria may also include verifying that the organization is not listed in any fraud, phishing, or government restricted entities, or anti-terrorism databases. Additionally, the trust entity 14 is configured to verify that the organization requesting a certificate is the organization to which the certificate will be issued.

TLS certificate organization validation processes may include OV and EV certificate orders, where certain industry standards or baseline requirements are provided such that the trust entity 14 can properly validate the organization included in the certificate request before issuing the certificate. These checks can be used to make sure the organization is who they say they are, to verify the organization's legal existence, and to see if an organization is trustworthy enough for an OV or EV TLS certificate.

To complete your organization's validation, the validation agent (or others) of the trust entity 14 are configured to validate the existence of the organization included in their certificate order and make sure it is in good standing. There may be specific actions that go on behind the scenes in the organization validation process. Nevertheless, some things may be noted that can help one to understand what a requestor may expect after placing an order. For example, to verify an organization's existence, status, etc., the validation agent may check corporate registries, such as local government registration records, Dun & Bradstreet, Google Maps, etc. They can also check for a history of fraud or phishing and whether the organization is in government-restricted entities or anti-terrorism databases. Additionally, they can also verify the organization requesting the certificate is, in fact, the organization that gets the certificate.

The trust entity 14 may issue certificates and conduct background validation checks for various types of organizations, such as banks, universities, businesses, non-profits, etc. The validation agent may verify the organization's status and determine if it is still an active business. They can check legal address to verify the legal, physical address of the organization. They can check blocklists to verify that the organization does not appear on any “do not issue” lists for organizations or for the country where the organization is located. Also, fraud and phishing lists are checked to verify the organization does not appear on any “bad actor” lists.

The agent can also check request authenticity to confirm the certificate requestor's authority to order a certificate for your organization. For instance, much of the organization verification work may be done on the back end of the trust entity 14. The validation agent may generally ask for very little help from the requestor. However, the validation agent may contact the requestor for an “acceptable” document to help confirm that the organization is legally and lawfully formed.

To confirm authority to order certificates for the organization, the validation agent may first find a verified, publicly listed organization phone number. The organization's phone number may be from a third party or independent listing. Next, they use the verified phone number to speak with someone who represents the organization, such as an organization or technical contact, to verify the authority to request a certificate for the organization. The agent can speak with the contact person, the certificate requestor, or other representatives.

Once an organization has placed an order, the trust entity 14, which may include a global team of experts, will start the validation process. That is, organizations throughout the world may request certificates and go through validity check based on the criteria, baseline requirements, standards, protocols, etc. of the various jurisdictions in which the organization operate. The validation agent assigned to particular validation job (e.g., for a specific client, requestor, organization, end entity, etc.) is configured to validate the certificates according to strict guidelines put forth by the Certification Authority Browser Forum. Because of the strictness of these guidelines, validation does not happen immediately. Instead, because of the diligence and attention to detail as put forth by these validation agents, they are able to ensure the type of robust protections that an organization might rely on to keep their sites secure.

### General Computing System

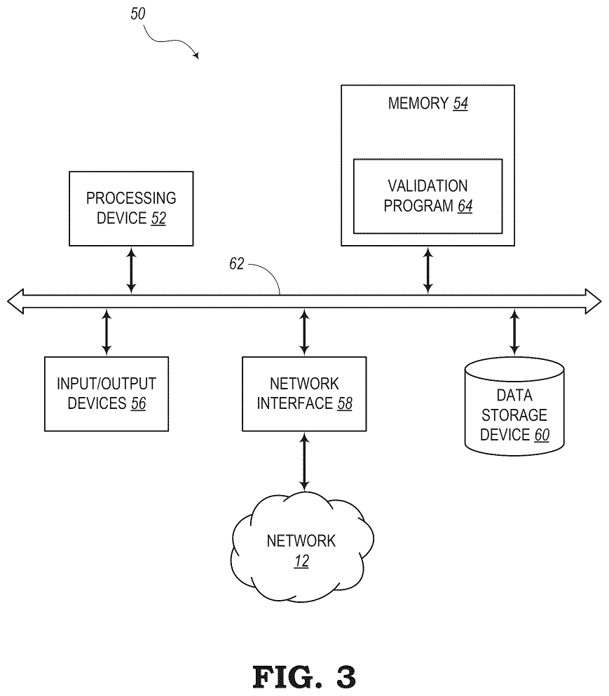

FIG. 3 is a block diagram illustrating an embodiment of a computing system 50 that represents a computer, laptop, tablet, mobile phone, or other computing device used by a validation agent (or other users) associated with the trust entity 14. For example, the computing system 50 may include one or more of the various components, devices, or systems of the trust entity 14 shown in FIG. 2, such as the web and API modules 24, the RA 26, the certification system 28, or any of the other devices described herein. In particular, the computing system 50 may be a standard-issue computer that is operated by a validation agent for performing validation jobs for clients.

The processing device 52 may be a digital computer that, in terms of hardware architecture, generally includes a processing device 52, memory 54, input/output (I/O) devices 56, a network interface 58, and a data storage device 60. It should be appreciated by those of ordinary skill in the art that FIG. 3 depicts the processing device 52 in an oversimplified manner, and a practical embodiment may include additional components and suitably configured processing logic to support known or conventional operating features that are not described in detail herein. The components (52, 54, 56, 58, 60) are communicatively coupled via a local interface 62. The local interface 62 may be, for example, but not limited to, one or more buses or other wired or wireless connections, as is known in the art. The local interface 62 may have additional elements, which are omitted for simplicity, such as controllers, buffers (caches), drivers, repeaters, and receivers, among many others, to enable communications. Further, the local interface 62 may include address, control, and/or data connections to enable appropriate communications among the aforementioned components.

The processing device 52 is a hardware device for executing software instructions. The processing device 52 may be any custom made or commercially available processor, a Central Processing Unit (CPU), an auxiliary processor among several processors associated with the computing system 50, a semiconductor-based microprocessor (in the form of a microchip or chipset), or generally any device for executing software instructions. When the computing system 50 is in operation, the processing device 52 is configured to execute software stored within the memory 54, to communicate data to and from the memory 54, and to generally control operations of the computing system 50 pursuant to the software instructions. The I/O devices 56 may be used to receive user input from and/or for providing system output to one or more devices or components.

The network interface 58 may be used to enable the computing system 50 to communicate on a network, such as the Internet. The network interface 58 may include, for example, an Ethernet card or adapter or a Wireless Local Area Network (WLAN) card or adapter. The network interface 58 may include address, control, and/or data connections to enable appropriate communications on the network. A data storage device 60 (e.g., one or more databases, data stores, etc.) may be used to store data. The data storage device 60 may include volatile memory elements (e.g., random access memory (RAM, such as DRAM, SRAM, SDRAM, and the like)), nonvolatile memory elements (e.g., ROM, hard drive, tape, CDROM, and the like), and combinations thereof.

Moreover, the data storage device 60 may incorporate electronic, magnetic, optical, and/or other types of storage media. In one example, the data storage device 60 may be located internal to the computing system 50, such as, for example, an internal hard drive connected to the local interface 62 in the computing system 50. Additionally, in another embodiment, the data storage device 60 may be located external to the computing system 50 such as, for example, an external hard drive connected to the I/O devices 56 (e.g., SCSI or USB connection). In a further embodiment, the data storage device 60 may be connected to the computing system 50 through a network, such as, for example, a network-attached file server.

The memory 54 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 54 may incorporate electronic, magnetic, optical, and/or other types of storage media. Note that the memory 54 may have a distributed architecture, where various components are situated remotely from one another but can be accessed by the processing device 52. The software in memory 54 may include one or more software programs, each of which includes an ordered listing of executable instructions for implementing logical functions. The software in the memory 54 includes a suitable Operating System (O/S) and one or more programs. The O/S essentially controls the execution of other computer programs, such as the one or more programs, and provides scheduling, input-output control, file and data management, memory management, and communication control and related services. The one or more programs may be configured to implement the various processes, algorithms, methods, techniques, etc. described herein.

The computing system 50 further includes a validation program 64 that may be implemented in any suitable combination of hardware (e.g., configured in the processing device 52) and/or software/firmware (e.g., configured in the memory 54). The validation program 64 may be stored in any suitable non-transitory computer-readable media (e.g., the memory 54) and may include computer logic or code having instructions that enable or cause the processing device 52 to perform certain actions as discussed in the present disclosure.

Of note, the general architecture of the computing system 50 can define any device described herein. However, the computing system 50 is merely presented as an example architecture for illustration purposes. Other physical embodiments are contemplated, including virtual machines (VM), software containers, appliances, network devices, and the like.

In an embodiment, the various techniques described herein can be implemented via a cloud service. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. The phrase “Software as a Service” (SaaS) is sometimes used to describe application programs offered through cloud computing. A common shorthand for a provided cloud computing service (or even an aggregation of all existing cloud services) is “the cloud.”

In addition, the computing system 50 includes a validation program 64, which may be implemented in any suitable form of hardware (e.g., on the processing device 52) and/or software or firmware (e.g., on the memory 54). The validation program 64 may be stored on a non-transitory computer-readable medium (e.g., memory 54, data storage device 60, etc.) and may include logic code, software, computing instructions, etc. that enables, causes, or programs the processing device 52 to perform various validation services.

According to a first validation service implementation, the validation program 64 may enable the processing device 52 to obtain enrollment information submitted from an organization to a trust entity, whereby the enrollment information may include details of the organization. In response to a web browser of the trust entity being navigated to a webpage associated with the organization, the first validation service implementation further includes a step of extracting identifying data from the webpage. Based on a comparison between the identifying data and the details of the organization, the first validation service implementation also includes providing feedback to a validation agent of the trust entity regarding a validation status of the organization.

According to a second validation service implementation, the validation program 64 may enable the processing device 52 to display client information submitted by a client on a home screen of a user interface being operated by a validation agent responsible for executing a validation job for the client. Also, the second validation service implementation includes a step of displaying a validation sources tab on the home screen. In response to a selection of the validation sources tab, the second validation service implementation further includes a step of displaying links to vetted web sources from which data can be obtained to assist the validation agent with executing the validation job.

According to a third validation service implementation, the validation program 64 may enable the processing device 52 to provide an initiation option to a validation agent in response to the validation agent selecting a portion of a document retrieved from a reliable web source, the initiation option allowing the validation agent to initiate an automated validation procedure. In response to the validation agent selecting the initiation option, third validation service implementation programs the processing device 52 to perform the automated validation procedure. For example, the automated validation procedure includes a) a comparing sub-step in which the portion of the document selected by the validation agent is compared with client information included in a certificate request, and b) a compliance sub-step in which it is determined whether or not a comparison, based on the comparing sub-step, complies with a validation guideline.

### [[DIGIPAT-80]] Automated Webpage Capture and Validation

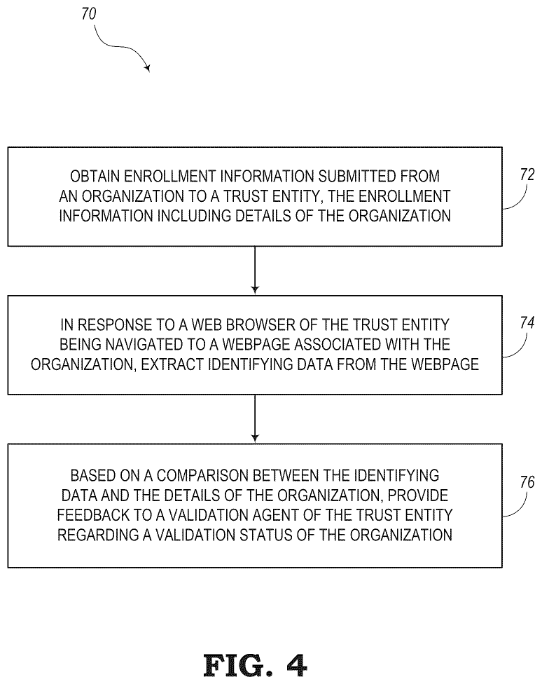

FIG. 4 is a flow diagram illustrating an embodiment of a method 70 for determining a validation status of an organization. The method 70 includes a step of obtaining enrollment information submitted from an organization to a trust entity, as indicated in block 72, wherein the enrollment information includes details of the organization. In response to a web browser of the trust entity being navigated to a webpage associated with the organization, the method 70 further includes a step of extracting identifying data from the webpage, as indicated in block 74. Based on a comparison between the identifying data and the details of the organization, the method 70 also includes providing feedback to a validation agent of the trust entity regarding a validation status of the organization, as indicated in block 76.

According to some embodiments, the steps of extracting the identifying data (block 74), making a comparison (block 76), and providing the feedback (block 76) may be automated actions involving Artificial Intelligence (AI) operations. The AI operations, for example, may further include actions of automatically navigating the web browser to the webpage, automatically converting the webpage to a string, and automatically extracting the identifying data from the string. The web browser, in some cases, may be associated with the validation agent, where the step of extracting the identifying data from the webpage (block 74) may be initiated in response to receiving a specific capturing instruction from the validation agent. The details of the organization (block 76) may include organization name, organization address, trade registration number, trade registration status, and/or trade registration date.

In response to the web browser being navigated to multiple webpages associated with the organization, the method 70 may further include a step of extracting multiple sets of identifying data from the multiple webpages. The multiple webpages may be selected from a list of approved web resources where the identifying data can be collected. The list of approved web resources may include government websites, Secretary of State websites, government trade registry databases, trade registration websites, organization registry websites, institution websites, and/or banking websites. Furthermore, in response to detecting that the multiple webpages use different naming conventions for the multiple sets of identifying data, the method 70 may further include a step of performing an interpretation procedure to remove ambiguity with respect to the different naming conventions.

In some embodiments, the step of extracting identifying data from the webpage (block 74) may include a) capturing a screenshot of the webpage, and b) performing an optical character recognition procedure to collect the identifying data. When the comparison between the identifying data and the details of the organization results in a match, the method 70 may further include a) setting the validation status to confirm that the organization is valid, b) providing feedback to the validation agent that the organization is valid, and c) in response to the validation agent verifying the validation status, forwarding a Certificate Signing Request (CSR) to a Root Certificate Authority (Root CA) or Intermediate CA (ICA) associated with the trust entity for requesting a digital certificate for the organization. In some embodiments, when the comparison between the identifying data and the details of the organization does not result in a match, the method 70 may include the steps of a) setting the validation status to invalid, and b) providing feedback to the validation agent explaining discrepancies in the comparison, whereby the discrepancies may include missing information, additional fields needed, misspellings, mistyping or entry errors, incorrect webpage, incorrect section of the webpage, incorrect enrollment information, and/or incorrect organization information.

In response to the browser being navigated to a webpage written in a language different from a base language, the method 70, according to some embodiments, may further include a step of automatically translating the webpage to the base language. The enrollment information, for example, may further include a type of validation to be performed for the organization, the types of validation selected from Domain Validation (DV), Organization Validation (OV), and Extended Validation (EV). The type of validation, for instance, may define a number of fields and types of fields to which the extracted identifying data is to be assigned. In some embodiments, the method 70 may further include a step of categorizing the identifying data into the fields based on a URL of the webpage.

Thus, the present disclosure includes systems and methods for automatically capturing a web page, analyzing it, and completing a validation. Generally, there is a problem in conventional systems related to capturing validation specific data from a third part API. One solution as described in the present disclosure includes adding automation in order to reduce the amount of unnecessary data required while analyzing the most relevant data for the sake of validation. Thus, the present disclosure describes systems that can automatically fetch a webpage containing organization information, convert the web page to a string, and then use AI to get the relevant information from the result extract.

AI may be used to identify key validation-related details, which may then be used in the validation checks, such as:
a) Organization Name
b) Organization Address
c) Organization Registration Number
d) Organization Registration Status
e) Organization Registration Date
AI could analyze the extracted data and provide the system with the key validation fields.

With the data fields identified, the systems and methods of the present disclosure may be configured to evaluate against the submitted validation data and then automatically complete validation checks on fields where the data matched. Any fields where the data did not match, or where the data was inconclusive, the system may flag the data for a human agent to review. In some embodiments, the system would not require validation to manually upload any documents. The system may be configured to automatically look up information submitted for validating an organization based on the location of the organization. The system may also do the same for re-validation of organizations.

In some embodiments, the systems and methods may include a GPT integration to automatically validate any document added by the validation team to obtain organization data and to verify the details from the document, thereby reducing the need to manually complete validations in a validation tool (e.g., validation program 64), validation workbench, component, or system.

AI may be configured to perform a visual check for organization data and then the validation tool can present the findings and the document for validation to review the results confirming the data field verification. This may reduce errors made by validation data reviewing data in the tool or workbench. This will also add an additional system check where the system performs confirmations of data submitted vs data included in a verification document. A validation agent will normally still be presented with findings and will have to approve the results so that the trust entity 14 will comply with validation requirements, but this will reduce human errors in the process.

### User Interaction

According to some embodiments, the validation agent may use the validation program 64, execute the method 70, or otherwise perform validation jobs for a client. In one implementations, the process may include the following:
1. The validation agent uploads an image containing validation information to be verified.
2. Using a right-click operation, a menu or workflow may be presented, allowing the validation agent to associate the appropriate validation check with the document. For example, if an image contains the organization name, the validation agent may select an “Organization Name” check from the list of validation checks in the right-click menu.
3. This association will asynchronously send the image data and the associated validation data to GPT API for analysis, asking the AI to confirm that the given validation data is found in the image document
4. the result is displayed back to the user, such as in a toast message.

If successful, a success message is displayed to the agent, and the validation check is marked as “completed.” If unsuccessful due to the AI being unable to verify the data, then a message is displayed that the check was not completed, and the validation check is marked as “pending” and requiring manual intervention. Also, if unsuccessful due to data mismatch, then a message is displayed that the check was not completed, and the validation check is marked as “failed.”

### [[DIGIPAT-84]] Listing Approved Web Sources and Automatically Highlighting Validation Evidence

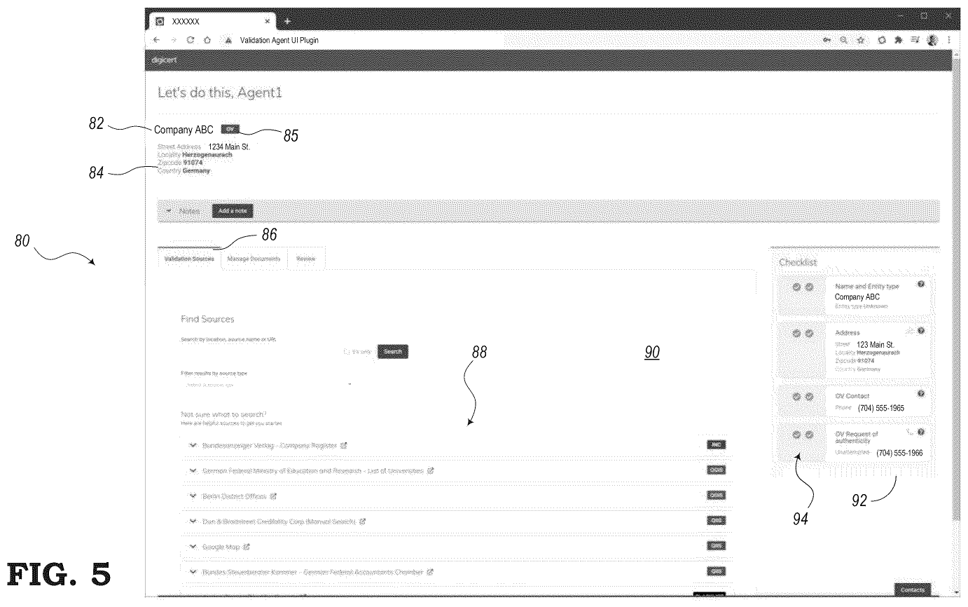

FIGS. 5-10 are screenshots showing examples of a User Interface (UI) that may be part of a computing system of a validation agent, who may be employed by the trust entity 14. The UI may provide output to the user (validation agent) and receive input from the user. The UI may be associated with the execution of a validation tool (e.g., validation program 64) that enables the validation agent to perform a validation job. For instance, the validation job may essentially involve confirming or verifying the identity of a client (e.g., organization 16, end entity 22, user, network device, etc.).

FIG. 5 is a screenshot showing a home page 80 associated with the validation tool. The home page 80 may include a recognition of the validation agent (e.g., “Let's do this, Agent1”) and general information of the client (e.g., “Company ABC”) being validated. The client information may include a client name 82 (e.g., organization name) and the physical address 84 (e.g., street address, city, state, country, etc.) of the client. The client name 82 and physical address 84 may be general information for representing a specific validation job (e.g., an order, a task, a file, etc.). Also, the home page 80 may include a type of validation 85 being performed, as requested by the client (e.g., in a certificate request). In this example, the type of validation 85 indicates Organization Validation (OV).

Furthermore, the home page 80 includes a validation source tab 86. When selected (e.g., as a default, by a mouse click on the validation source tab 86, etc.), the home page 80 is configured to show a list of vetted web sources 88 in a panel 90. The panel 90 may also provide a manual search field, search button, and other features. In particular, the vetted web sources 88 may be pre-selected beforehand based on determining that the sources are reliable and official. The vetted web sources 88 may be listed in an order starting with the most significant or reliable. Also, the list may be customized based on the client being validated and the jurisdiction in which the client is operating. For example, to gather information of an organization based in California, the California Secretary of State website may be a valuable resource for getting reliable information of the organization, particularly regarding name information, address, contact information, trade registration information, etc.

Also, the home page 80 further includes a checklist box 92. The checklist box 92 is configured to list a number of items that are to be validated for completing the validation job. For example, the checklist box 92 includes items that may be needed for the type of validation 85 (e.g., OV) being performed. In this example, the OV checklist has items including a) name and entity type, b) address, c) contact information (e.g., email address or phone number of admin), and d) authenticity of request or requestor. When each item is positively confirmed, the home page 80 may be configured to provide some type of mark 94 or indication (e.g., checkmark) showing completion of that specific item.

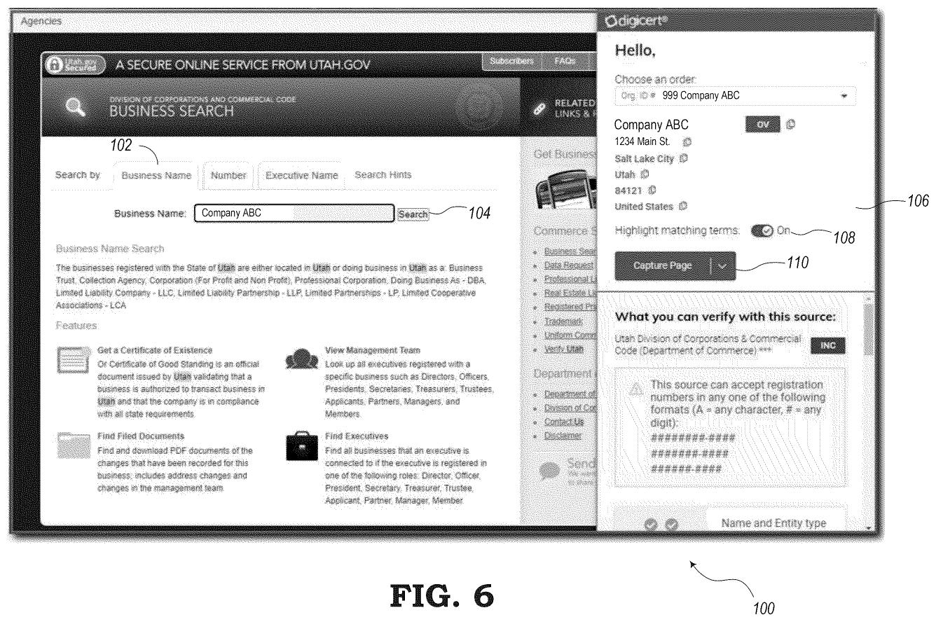

FIG. 6 is a screenshot showing the validation tool being navigated to a reliable website 100 from one of the vetted web sources. Navigation to the reliable website 100 may be the result of selecting a specific web source site of the list of vetted sources 88. As shown in this example, the reliable website 100 is a secure online service site related to the Utah government. In some embodiments, the validation tool may automatically select an applicable tab 102 and enter the client name 82 into a search field 104 in order to navigate to an appropriate webpage for gathering data.

In addition, the validation tool is configured to display an overlay window 106 (e.g., tile, panel, etc.) over part of the display of the reliable website 100 in the UI. The overlay window 106 may include the client information (for reference) and may also include a highlighting switch 108 and capture button 110. When the highlighting switch 108 is toggled “on” (e.g., by default, by mouse action, etc.) to turn on the highlighting feature, the validation tool is configured to search the reliable website 100 and highlight the information that is related to the client data is intended to be verified. For example, any or all of the items of the checklist box 92 may be highlighted on the page. The action of highlighting may include showing text with a yellow background to make the text stand-out and/or other suitable highlighting techniques, such as circling the text, bolding the text, blurring other parts of the page other than the text itself, and/or other techniques.

When the capture button 110 is pressed (e.g., using a mouse click), the validation tool is configured to capture the reliable website 100 (with or without the highlighting). The action of capturing the webpage may include a screenshot capturing feature that obtains a visual picture of the webpage. In other embodiments, capturing the webpage may include performing an Optical Character Recognition (OCR) technique to store a string of characters (e.g., text) from the webpage. In some embodiments, the capturing may include visual and OCR techniques. Furthermore, the step of capturing, upon selection of the capture button 110 may include obtaining Hypertext Markup Language (HTML) information, Uniform Resource Locator (URL) information, and/or Fully Qualified Domain Name (FQDN) information.

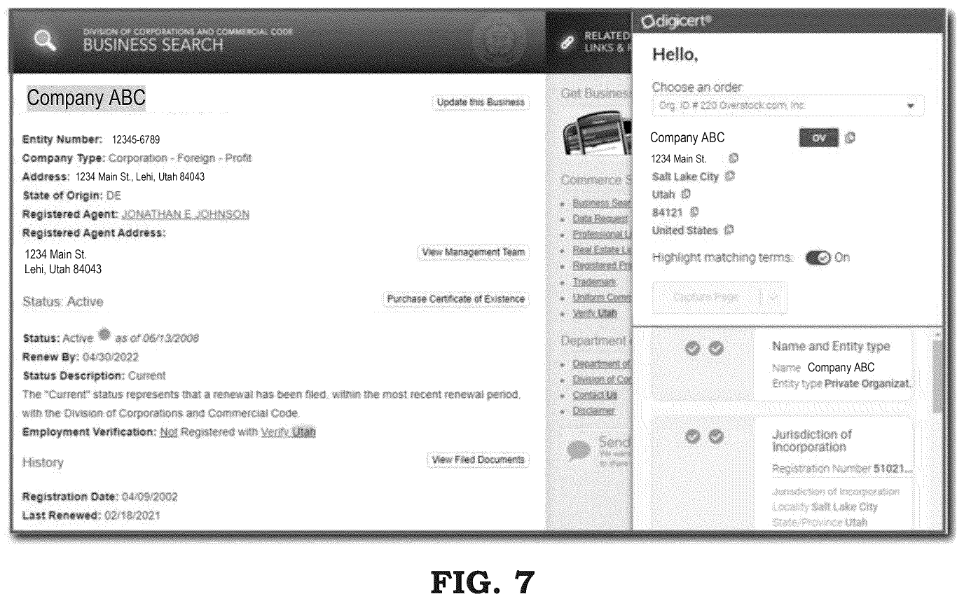

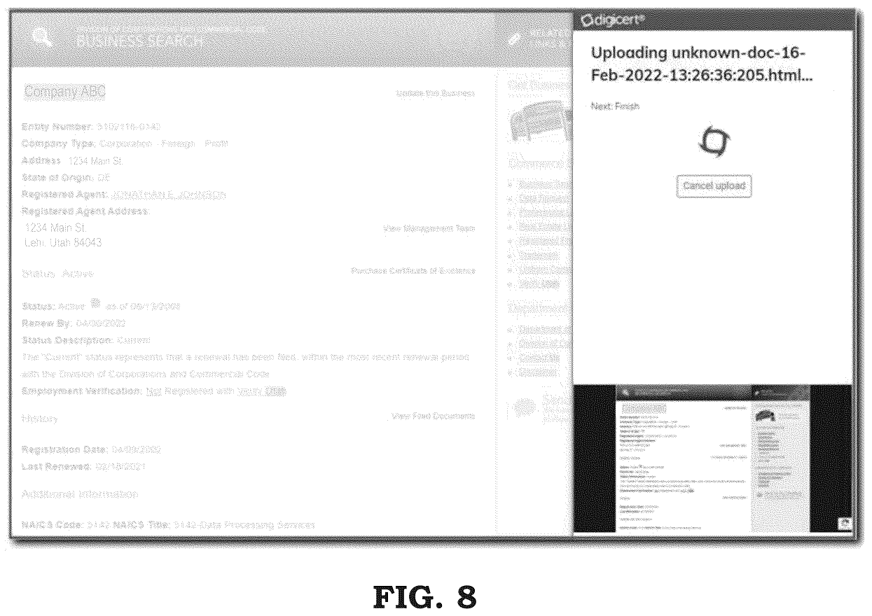

FIG. 7 shows the reliable website 100 of FIG. 6 when the user has pressed the capture button 110. FIG. 8 shows the reliable website 100 when the captured image and/or text information is being uploaded to a storage device associated with the validation tool. When stored, the captured information may be stored as documents having metadata, where the metadata may include information for identifying which client the captured information is related to and/or the specific validation job being performed.

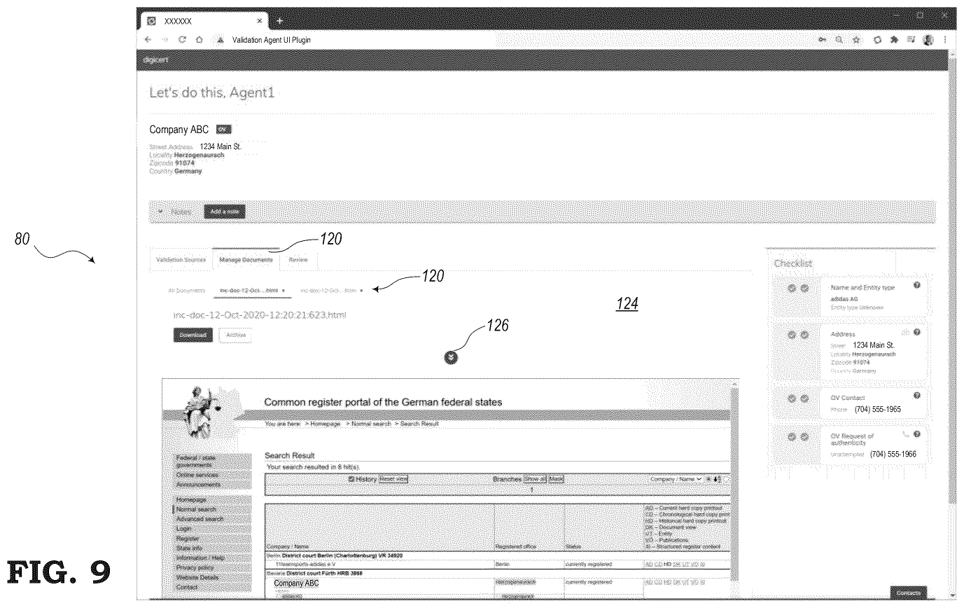

FIG. 9 shows a screenshot of the home page 80 of FIG. 5 when the user has pressed a second tab 120 for managing documents. Therefore, after the navigating to various reliable websites, the user may gather certain documents (e.g., screenshots of relevant data on reliable webpages, text obtained by OCR, etc.) and stored them in a way where they can be retrieved during a later stage in the validation job. That is, pressing the second tab 120 may be part of the later stage, where the user (validation agent) may look through the captured information to verify that retrieved information matches the client's submitted information. In some embodiments, the validation tool may automatically match the submitted client data with the data obtained from official records to see if the information can be validated, which can eliminate human error by noting mistakes in data entry, misspellings, using expired data, using data from unapproved sources, etc. In the example of FIG. 9, the user may select one of the saved documents from a list 122, which can then be displayed in a display window 124. A scroll button 126 may be used to scroll through the retrieved document. In some embodiments, the relevant items used for validation that were highlighted in previous steps may still be saved with the highlighting features and displayed in the display window 124 with the highlighting features.

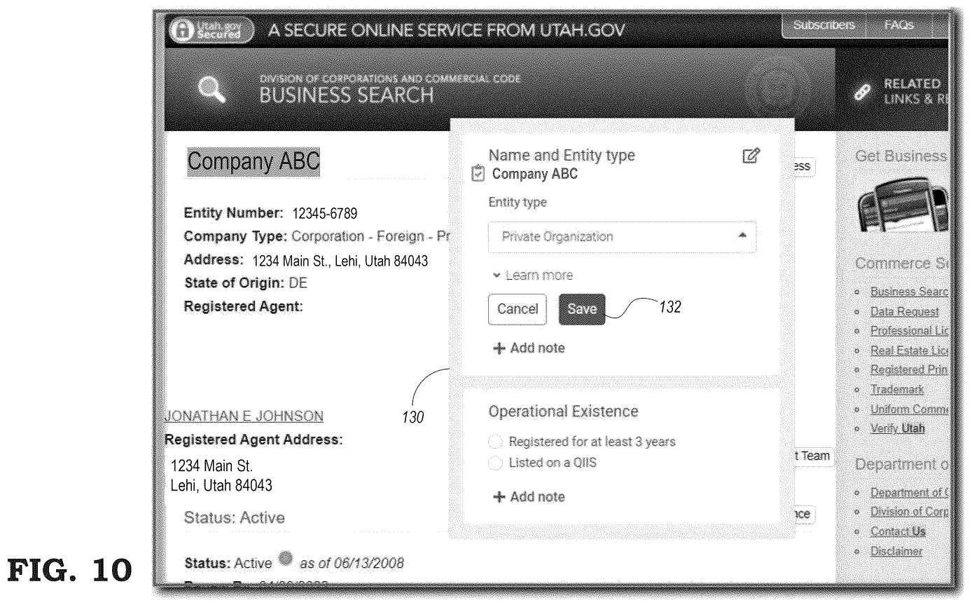

FIG. 10 is a screenshot showing an example of a vetted website (e.g., reliable website 100 of FIG. 6) with a tile 130 (e.g., window, panel, etc.) superimposed over part of the displayed website. The tile 130 may include a validation status. For example, the tile 130 may show the client name in a positive manner (e.g., green, with a checkmark, etc.) to show that the client information has be validated. The tile 130 may also include a save button 132 to allow the validation agent to save a file related to the validation job or completion of the validation job.

### Process Involving a Validation App

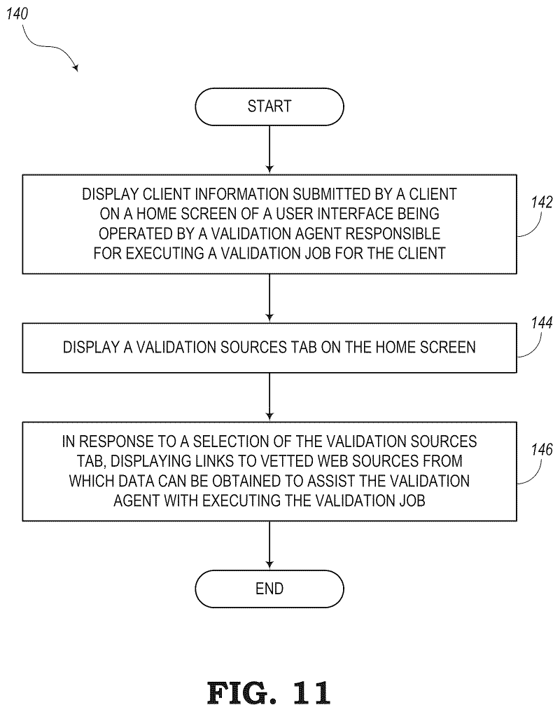

FIG. 11 is a flow diagram illustrating a method 140 associated with a validation tool. For example, the validation tool is configured to be executed by a validation agent for validating information associated with a client (e.g., organization). The validation tool may be part of the validation program 54 shown in FIG. 3 and may include logic code, software, firmware, or the like, and may be stored on a non-transitory computer-readable medium. As such, the logic code may include instructions or commands that enable or cause a processing system (e.g., processing device 52) to perform certain functionality for validating information regarding the identity of the client.

As shown in FIG. 11, the method 140 includes a step of displaying client information submitted by a client on a home screen of a user interface being operated by a validation agent responsible for executing a validation job for the client, as indicated in block 142. Also, the method 140 includes a step of displaying a validation sources tab on the home screen, as indicated in block 144. In response to a selection of the validation sources tab, the method further includes a step of displaying links to vetted web sources from which data can be obtained to assist the validation agent with executing the validation job, as indicated in block 146.

Prior to displaying the links to the vetted web sources (block 146), the method 140 may further includes a step of performing a vetting procedure to pre-select a list of reliable websites that are applicable for execution of the validation job for the client. For example, the reliable websites may be identified by Uniform Resource Locator (URL) information or Fully Qualified Domain Name (FQDN) information. In some embodiments, the method 140 may further include periodically updating the vetting procedure, which may include a) retrieving up-to-date knowledge of industry standards, protocols, and guidelines, b) adding any reliable websites to the list based on changes to the industry standards, protocols, and guidelines and/or changes to the reliable websites themselves, c) deleting any unreliable websites from the list based on changes to the industry standards, protocols, and guidelines, changes to the unreliable websites, and/or information regarding the unreliable websites being added to a government restricted list, trade embargo list, terrorism list, fraud list, or spam list, and d) identifying an updated list of websites by their URL and FQDN information.

According to some implementations, the method 140 may further include a step of displaying a checklist on the home screen, where the checklist may include validation items to be verified for the client to complete the validation job. The checklist, for example, may include a specific number and category of validation items based on a type of validation job being performed. That is, the type of validation job may include Domain Validation (DV), Organization Validation (OV), or Extended Validation (EV). Upon determining that evidence obtained from one of the vetted web sources positively verifies an identified validation item of the validation items, the method 140 may further include marking the identified validation item in the checklist with a visual indicator (e.g., checkmark) to express completion of the identified validation item.

In response to a selection of one of the links to obtain data from a specific vetted web source, the method 140, in some embodiments, may include the steps of a) navigating a web browser associated with the validation agent to a webpage of the specific vetted web source for displaying data associated with the client, where the data includes evidence that verifies identifying information about the client, and b) displaying an overlay panel over a portion of the webpage. The overlay panel, according to some embodiments, may include at least a highlighting toggle switch, wherein, in response to the highlighting toggle switch being turned on, the method 140 may include highlighting the evidence on the webpage. The overlay panel, for instance, may include at least a page capture button, wherein, in response to the page capture button being pressed, the method 140 may include a) capturing an image of the webpage using Optical Character Recognition (OCR), and b) uploading the image to a storage device associated with the validation tool, wherein the image may be configured to be submitted as evidence for completing the validation job. The overlay panel, in some cases, may include at least a page capture button, wherein, in response to the page capture button being pressed, the method 140 may include obtaining the evidence using a Document Object Model (DOM) or obtaining the evidence as an HTML version of the webpage.

The method 140, in some embodiments, may also include comparing the client information with the data obtained from one or more of the vetted web sources to detect typographical errors and/or other data entry mistakes. The client information, for example, may include at least name, address, contact data, and validation request data. For example, the client may be an organization, an individual user, or a network device, and the validation agent may be an employee of a trust entity. Upon the validation agent completing the validation job, the method 140 may further include forwarding a certificate request to a Root Certificate Authority (Root CA) or Intermediate CA (ICA) of the trust entity for creating a digital certificate for the client. The certificate request may be submitted by the client to the trust entity along with the client information. The validation tool may enable the validation agent to execute multiple validation jobs for multiple clients simultaneously. Also, the method 140 may include a step of selecting the vetted web sources from a plurality of reliable web sources based on a jurisdiction in which the client operates.

Therefore, the present disclosure provides systems and methods to direct a validation agent to a vetted web source, automatically highlight validation evidence, and upload a document of the vetted web source in order to submit this information as evidence for the completion of a validation job.

Historically, validation of submitted customer data has been a heavily involved manual process. The human error rate is much higher in such an environment, where it is easy to inaccurately enter data with small typos, misread information on a source, misunderstand an industry requirement, use out-of-date sources, etc. These mistakes, no matter how small, can lead to a mis-issuance of a certificate, which puts the trust entity 14 out of compliance with the baseline requirement.

The systems and methods of the present disclosure allow agents to minimize the risk of human error by removing several manual steps from this process and adding some automated features to the process so that an agent can solely focus on reviewing the document for evidence of legitimate data rather than spending time visually searching for evidence and manually preparing a document for upload to the validation system. For example, the embodiments of the present disclosure may include a new workflow as follows:
1) from the validation system, an agent can directly navigate to a vetted source from an up-to-date built-in list of allowed sources, thereby mitigating the risk of using an outdated source.
2) Once on the page, an in-house browser extension application will analyze the URL to confirm the source is still a valid source.
3) Based on the source URL and the opened validation request, the system can display to the user which baseline requirement items are allowed to use this particular source and web page as evidence of the legitimacy of the submitted customer data, which mitigates the risk of the agent misunderstanding a baseline requirement and what entails proper evidence to fulfill the requirement.
4) Next, the system will analyze the data on the web page to compare it to the submitted customer data and highlight only the found key values that are allowed to use the source as evidence, removing the risk of typos either from manual typing or copy and pasting and also the risk of misunderstanding which data is allowed to use the source as evidence of a baseline requirement. This also minimizes the risk of comparing information on the web page vs the submitted customer data, as the agent can now more efficiently scan and review the highlighted areas rather than blindly searching the whole document one key data value at a time.
5) Lastly, after reviewing the results, in a right-click operation, the agent can have the webpage captured, with the highlighted text, uploaded to the validation system, and automatically redirected back to the proper validation request in the system that was fulfilled by the document, thereby minimizing the risk of highlighting the incorrect data due to misreading errors and uploading the document to the correct validation request in the system.

As described herein, the Baseline Requirements refer to validation guidelines for the Issuance and Management of Publicly-Trusted Certificates and describe a subset of the requirements that a CA typically must meet in order to issue digital certificates for SSL/TLS servers to be publicly trusted by browsers. The requirements do not necessarily address all of the issues relevant to the issuance and management of publicly-trusted certificates, and the CA/Browser Forum may update the requirements to address both existing and emerging threats to online security. The currently used version of the baseline requirements addresses certificates used for authenticating servers accessible through the Internet, code signing, S/MIME, time-stamping, VoIP, IM, Web services, and/or other policies and guidelines that may be covered in future versions.

One objection of the present systems is to create a document capture browser plugin to capture a copy of a source webpage and submit to workbench for validation evidence. The plugin may be a workbench external capture plugin for Chrome or other browsers. This plugin may be the main tool that validation agents will use to capture evidence to complete validation requirements. In some cases, the plugin may capture the Document Object Model (DOM) of the page so that the validation agent can get an exact copy as validation evidence.

The plugin will also automatically submit the document to a workbench order that the validation agent is working on. Then, the agent can select the data on the document and associate it with validation requirement elements of User Interface (UI) windows, panels, tiles, etc. The validation guidelines or baseline requirements may be listed in these windows, panels, or tiles in a checklist. When the computing system 50 is configured as a standard-issue laptop or computer with an IT department with managed software, UIs, images, etc., the trust entity 14 can control the applications and settings for workbench usage.

The plugin may also authenticate through the pages of the validation program 64, UIs, etc. and may utilize an existing user token to allow the agent to gain access to the workbench system. Thereafter, the agent can automatically submit the page captures as documentation to be used in the validation process.

The implementation of the plugin may be focused on achieving one or more engineering goals, such as 1) removing the dependency on third party tools (e.g., Hypersnap) and 2) eliminating the need to continue supporting Magic Drive or a network folder that validation agents traditionally use to save a screenshot and upload to legacy workbench systems.

The plugin is also able to capture an HTML version of the webpage vs images that agents used historically in order to simplify the data text confirmation process. The systems and methods described herein are configured to reduce reliance on various third party OCR services or tools (e.g., Tesseract) for every validation document. Although certain OCR tools (e.g., internally or externally developed) can still be available for images that are uploaded, although validation agents might primarily be interacting with HTML documents, which may be easier for the system to help confirm data accuracy.

### User Interaction

According to various embodiments, the following actions may be taken for performing a validation job:
1. Validation agent begins working on an order in a workbench UI environment.
2. Validation agent clicks on a Validation Source to collect documentation.
3. Workbench opens a new browser tab for agents to search for organization data.
4. The new browser tab has an overlay panel showing the originating organization information and confirmation that the page the agent is browsing is an approved source for the requirement that needs to be completed. For instance, if the agent has multiple workbench pages open (multiple organizations or orders), the overlay panel may have a dropdown to select which order the agent wants to view and where captured documents will be sent.
5. The agent clicks on the capture button to capture a copy of the page being viewed.
6. The plugin automatically captures the DOM of the page and sends it to workbench in a message stream.
7. Workbench assigns the source information and category based on the FQDN of the page captured matching an approved validation source.
8. The agent closes the browser tab and returns to workbench to proceed with Right-Click Matching data from the document with submitted validation fields.

The validation agent (or analyst) may execute the following process:
Step 1) Agent selects an approved (or vetted) validation source (FIG. 5). When the agent begins working on an Organization Validation Manager, the user can click on a validation source on the “Find Sources” tab.

Step 2) Agent finds validation information on source page (FIG. 6). The plugin ensures agent stays in appropriate source. The source webpage may be opened up for Org authentication. In the meantime, Capture Plugin has an overlay panel showing the originating organization information, which helps the analysts to cross-check. When analysts search the organization's registration details on the source page, if the search result matches with the enrolling entity on the request, analysts can click on the “Capture Page” button, then the Capture Plugin will auto-upload the screenshot to the workbench.

Step 3) Agent uses plugin to capture a copy of the document to use in Workbench (FIG. 7). The plugin automatically uploads to the agent's working order (FIG. 8). The uploaded screenshot will be auto-assigned with the source name and type based on the source that the processing agent used. The agent can right-click on the document and see any requirement tiles that can potentially be completed with the document.

Step 4) Agent can use the document in the validation source (FIG. 9). The plugin includes associated site metadata to ensure the document came from an approve validation source. To view the document details, the user can click the scroll button 126 (or down arrow) to expand the document page section.

Step 5) Agent then highlights the key information on the document each time in order to bring up the relevant requirement tiles, the system will try to check and auto-match the information before completing the requirement tile (FIG. 10).

The choices for validation levels in the context of a Certificate Authority (CA) issuing an SSL/TLS certificate generally include DV (Domain Validation), OV (Organization Validation), and EV (Extended Validation). Each of these types provides a different level of validation and trust, with varying degrees of information required from the applicant.

### Domain Validation (DV)

The focus of the validation for DV includes verifying only the domain name ownership. The fields validated may include Domain Control, where the CA verifies that the applicant has control over the domain name associated with the certificate request. This is often done by sending an email to the domain's registrant or through DNS records (like adding a special record to DNS) or via HTTP file upload to confirm control of the domain. The certificate confirms that the domain is secured, but does not provide any identifying information about the organization or individual behind the domain. Common uses for DV includes personal websites, blogs, and internal sites where trust level for the organization is not as critical as other types.

### Organization Validation (OV)

The focus of validation for OV includes verifying domain ownership and also some basic information about the organization requesting the certificate. The fields validated may include Domain Control (e.g., same as DV), plus the CA may verify domain ownership or control as well. The CA may verify the existence of the organization (such as the legal status, physical address, and phone number) by cross-referencing business registries or third-party databases. Also, the CA may verify the identity of the requestor, entity, individual, etc. requesting the certificate is checked against the organization's information. This may be done by using additional documents, like company incorporation papers or listings in business databases. The certificate may include the organization's name, which provides a higher level of trust than a DV certificate. Common uses may include public-facing websites of companies, small businesses, and organizations where establishing trust in the organization is important (e.g., corporate websites).

### Extended Validation (EV)

Validation focus may include the most rigorous validation level, providing the highest level of trust by validating both the domain ownership and detailed information about the organization requesting the certificate. Fields validated may include a) Domain Control:
Same as DV and OV, domain control is verified; b) Organization Details: The CA performs an in-depth check of the organization, including verifying legal existence, operational status, physical location, and phone number; and c) Identity of the Requestor: The identity of the applicant requesting the certificate is verified in person or via stringent documentation processes;.

How EV is done requires substantial documentation, including legal documents like incorporation papers, a statement of active operations, and sometimes a face-to-face meeting or a notarized statement. The CA also verifies the organization's legal right to use the domain. The certificate includes the organization's name and additional legal details, which are displayed prominently in the browser (e.g., the green address bar, now less common but still used in certain browsers and contexts). Common uses may include high-profile websites handling sensitive information, such as banks, financial institutions, and major e-commerce sites, where users need to trust the entity behind the website.

### [[DIGIPAT-85 ]] Backup Verification Analysis for Validation Agent Actions

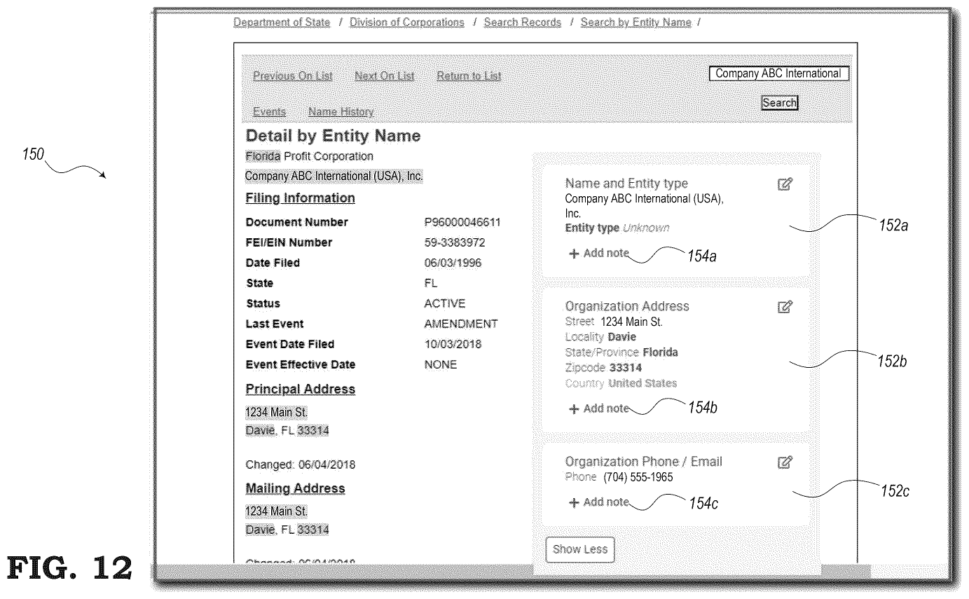

FIG. 12 is a screenshot illustrating an embodiment of a UI 150 used in a computing system by a validation agent. The UI 150 enables the validation agent to initiate an automated validation procedure. The validation agent can right-click on the document and the associated tiles will show up. He or she can then expand them to see all of the tiles that can be validated by using the same document. In the illustrated example, three different categories (i.e., name and entity type, organization address, and organization phone/email) are captured in one document, where the captured data is placed in three tiles including a first tile 152a, a second tile 152b, and a third tile 152c, respectively. Each of the tiles in the UI 150 also includes an annotation adding option 154a, 154b, 154c, respectively, allowing the user to enter annotations or notes regarding the validation job. For example, the validation agent may enter a note that the organization name as entered in the enrollment has be corrected according to official records.

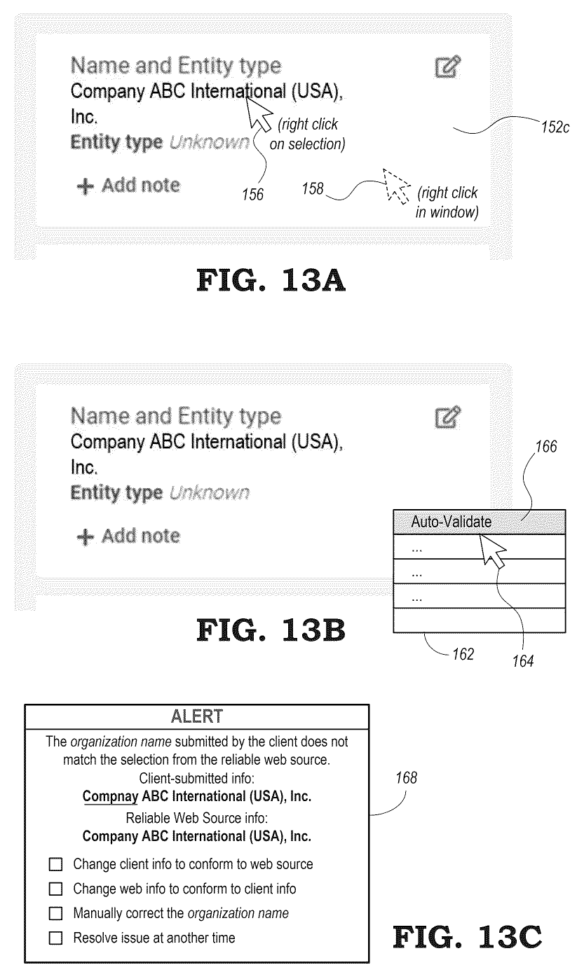

FIG. 13A is an example of a portion of the screenshot of FIG. 12 showing a selection option regarding the first tile 152a (i.e., name and entity type) or window. Using a selection or pointer device (e.g., mouse), a pointing icon 156 can be displayed, where the user can right-click on the element itself (i.e., right-click on the selection), which in this example includes the organization name of “Company ABC International (USA), Inc.” Alternatively, the validation agent may control a pointer, presented by a second icon 158, to initiate an automated validation process by right-clicking within the first tile 152a or window.

FIG. 13B illustrates a screenshot of the first tile 152a of FIG. 13A in which the validation agent has already right-clicked on the selection (or within the tile), according to the description of FIG. 13A, to reveal a menu 162. Using a selection device, shown by a pointing icon 164, the user can select an auto-validate option 166. Therefore, the initiating action by the user can be a simple process, which causes the validation tool to launch the auto-validate procedure. As such, the auto-validate can be a backup for double-checking the agent's analysis and avoid minor errors. Also, the tool can make sure the information from the document is still valid, based on an expiration date that may be unknown to the user.

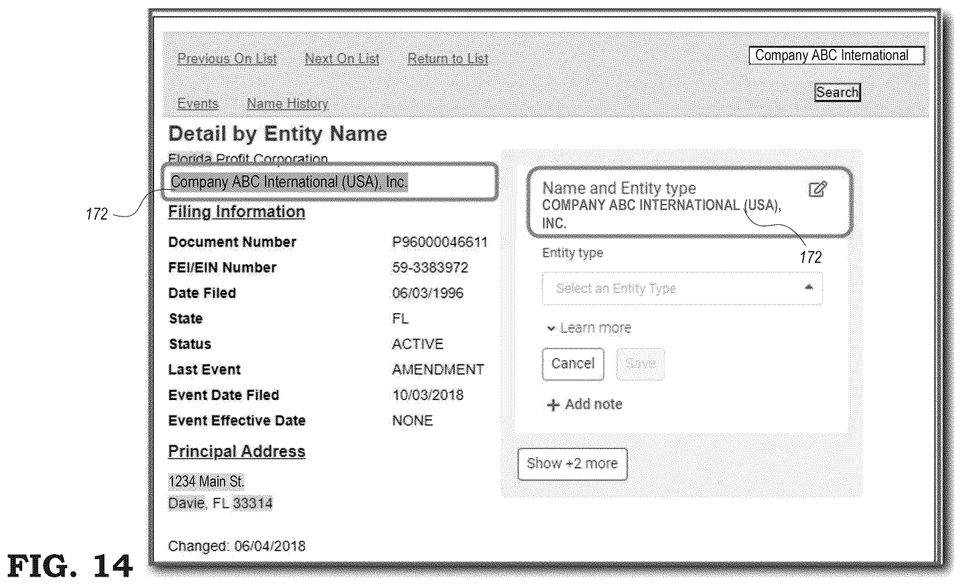

In response to running the auto-validate procedure, the validation tool can then provide feedback to the validation agent in any suitable form, such as pop-up windows or the like. If the auto-validation discovers an exact match between the client entered data and the data obtained from the reliable official webpage, then the tool may provide some type of indication that this validation element has met the validation guidelines, such as in the case with respect to FIG. 14. Otherwise, if there is an error (i.e., the client-entered data does not match the official data), then any suitable type of feedback can be communicated to the user, such as in the case with respect to FIG. 13C.

FIG. 13C is an example of feedback provided to the user when a negative or non-conforming situation is detected. For example, the tool may display a pop-up window 168 illustrating results of a comparison sub-step in which the selection of FIG. 13A does not match client submitted information. The pop-up window 168 may explain the error and may further include easily fixable solution options for the validation agent's selection, depending on further human review and other knowledge gained during the process.

FIG. 14 is an example of a screenshot showing a result of the comparison sub-step in which the selection matches the client information and is therefore in compliance with a specific validation guideline. One way to shown affirmation that the data matches, for example, is to show the validation selection elements in green colored text 172 or other affirming color and/or by using other suitable methods for showing validation of the information.

Therefore, to check off any requirement tile, the validation tool is configured to highlight the information on the document. For example, to verify the organization name and entity type, the tool highlights the organization name listed on the document. The system can “read” the highlighted information (e.g., selected by the validation agent) and auto-approve the information, as indicated in this example with the green colored text 172.

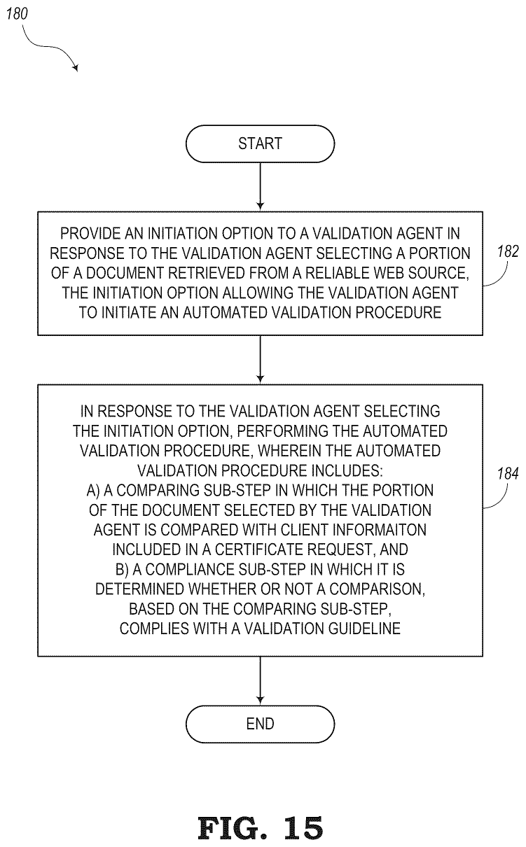

FIG. 15 is a flow diagram illustrating an embodiment of a third general method for enabling a validation agent to initiate an automated validation procedure. As shown, a method 180 includes a step of providing an initiation option to a validation agent in response to the validation agent selecting a portion of a document retrieved from a reliable web source, as indicated in block 182, the initiation option allowing the validation agent to initiate an automated validation procedure In response to the validation agent selecting the initiation option, the method 180 includes a step of performing the automated validation procedure, as indicated in block 184. For example, the automated validation procedure includes a) a comparing sub-step in which the portion of the document selected by the validation agent is compared with client information included in a certificate request, and b) a compliance sub-step in which it is determined whether or not a comparison, based on the comparing sub-step, complies with a validation guideline.

The method 180 may include a step of presenting the portion of the document in a preview window of a User Interface (UI), wherein the initiation option may be provided to the validation agent in response to the validation agent right-clicking on the portion of the document or inside the preview window. In some embodiments, it is determined that the comparison complies with the validation guideline when a string literal of the portion of the document is an exact match with a string literal of the client information. Also, the method may further include the steps of 1) obtaining an annotation from the validation agent, the annotation related to an execution of the automated validation procedure, and 2) adding the annotation to one of a) a digital certificate issued in response to the certificate request and b) a file associated with the execution of the automated validation procedure.

Furthermore, according to some embodiments, the method may include a step of providing an output in a User Interface (UI) associated with the validation agent, the output related to results of the compliance sub-step. The method may further include a step of highlighting the portion of the document in an affirmative manner when it is determined that the comparison complies with the validation guideline. Also, the method, in some embodiments, may include a step of indicating non-compliance when it is determined that the comparison does not comply with the validation guideline. The method can also include a step of providing resolution options including one or more of a) automatically conforming the client information to the portion of the document, b) automatically conforming the portion of the document to the client information, and c) allowing the validation agent to manually change the client information. In some implementations, the method can also repeat the automated validation procedure in response to the validation agent selecting one of the resolution options.

The automated validation procedure, for example, may further include a qualifying sub-step in which it is determined whether or not the document qualifies as valid evidence with respect to the validation guideline. Prior to the validation agent selecting the portion of the document, the method may include allowing the validation agent to upload the document from the reliable web source selected from a list of vetted web sources. The validation guideline, for example, may be one of a plurality of baseline requirements established by the Certificate Authority Browser Forum. Additionally, the method may further includes steps of a) providing a second initiation option to the validation agent in response to the validation agent selecting a second portion of the document, and b) in response to the validation agent selecting the second initiation option, performing the automated validation procedure for the second portion of the document with respect to a second validation guideline.

Therefore, according to this third general method, the validation tool (e.g., validation program 64) may be configured to enable a “one-click” automated analysis, which allows a user to enter annotations (if desired), and the tool may automatically complete a validation requirement or guideline (or at least double-check that the validation agent has not missed something). The systems and methods of the present disclosure are configured to overcome some of the issues of conventional systems that can result in human error during data validation stage as part of a certificate issuance.

In some cases, the auto-validation procedure can informally be referred to as “Right Click Magic,” which is described herein as a one-click system that removes the risk of human error when entering, comparing, reviewing, and understanding data to complete a validation guideline or baseline requirement. Again, the method may include a first step in which, after uploading a document from a vetted web source, an agent can use a select/highlight mechanism and right-click on the selected data to begin an automated analysis of the data based on the baseline requirements and the submitted customer data. If the data matches the customer data and the source fulfills a baseline requirement check, the method may include a second step where the system saves the agent's annotation, completing the validation requirement.

In the field of digital certificates, annotations may generally refer to additional data or comments attached to a file associated with a validation process and/or the actual certificate issued to a client. The annotations are configured to provide context or information beyond the core fields usually considered with certificates. The added annotations can include metadata to help interpret or manage the validation or certificate. Furthermore, the annotation additions may provide verification context. That is, the annotations may include details that clarify the circumstances or verification processes under which the certificate was issued, often helping with transparency and helping to resolve any future issues that might arise throughout the process.

The validation methods described herein are configured to reduce the risk of misreading data, ensuring that the analyzed data 100% matches with the customer-submitted data. For cases where the data does not match customer-submitted data, but could be resolved with human intervention, the system will display the results of the analysis so that the agent may then use their selected data to update the submitted customer data, again reducing human error by removing the need for manual typing which is at risk for typos. The agent also has the option to edit customer-submitted data manually and then, using Right Click Magic, validate that their entered data matches the data in the document, adding another layer of protection against typos and misreading of data. Lastly, if a document does not fulfill or qualify as valid evidence for a baseline requirement check, a warning can be displayed to the user, and the validation requirement is not completed. This reduces the risk of agents misunderstanding baseline requirements and mistakenly completing checks with invalid evidence.

### Processing Circuitry and Non-transitory Computer-Readable Mediums

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner—whether collectively, in subsets, or individually—thereby broadening the range of potential embodiments.

What is claimed is:

1. A method comprising steps of:
providing an initiation option to a validation agent in response to the validation agent selecting a portion of a document retrieved from a reliable web source, the initiation option allowing the validation agent to initiate an automated validation procedure; and
in response to the validation agent selecting the initiation option, performing the automated validation procedure, wherein the automated validation procedure includes a) a comparing sub-step in which the portion of the document selected by the validation agent is compared with client information included in a certificate request, and b) a compliance sub-step in which it is determined whether or not a comparison, based on the comparing sub-step, complies with a validation guideline.

2. The method of claim 1, further comprising a step of presenting the portion of the document in a preview window of a User Interface (UI), wherein the initiation option is provided to the validation agent in response to the validation agent right-clicking on the portion of the document or inside the preview window.

3. The method of claim 1, wherein it is determined that the comparison complies with the validation guideline when a string literal of the portion of the document is an exact match with a string literal of the client information.

4. The method of claim 1, further comprising steps of:
obtaining an annotation from the validation agent, the annotation related to an execution of the automated validation procedure; and
adding the annotation to one of a) a digital certificate issued in response to the certificate request and b) a file associated with the execution of the automated validation procedure.

5. The method of claim 1, further comprising a step of providing an output in a User Interface (UI) associated with the validation agent, the output related to results of the compliance sub-step.

6. The method of claim 5, further comprising a step of highlighting the portion of the document in an affirmative manner when it is determined that the comparison complies with the validation guideline.

7. The method of claim 5, further comprising a step of indicating non-compliance when it is determined that the comparison does not comply with the validation guideline.

8. The method of claim 7, further comprising a step of providing resolution options including one or more of a) automatically conforming the client information to the portion of the document, b) automatically conforming the portion of the document to the client information, and c) allowing the validation agent to manually change the client information.

9. The method of claim 8, further comprising a step of repeating the automated validation procedure in response to the validation agent selecting one of the resolution options.

10. The method of claim 1, wherein the automated validation procedure further includes a qualifying sub-step in which it is determined whether or not the document qualifies as valid evidence with respect to the validation guideline.

11. The method of claim 1, wherein, prior to the validation agent selecting the portion of the document, allowing the validation agent to upload the document from the reliable web source selected from a list of vetted web sources.

12. The method of claim 1, wherein the validation guideline is one of a plurality of baseline requirements established by the Certificate Authority Browser Forum.

13. The method of claim 1, further comprising steps of:
providing a second initiation option to the validation agent in response to the validation agent selecting a second portion of the document; and
in response to the validation agent selecting the second initiation option, performing the automated validation procedure for the second portion of the document with respect to a second validation guideline.

14. A system comprising:
a processing device; and
memory configured to store logical code having instructions that, when executed, enable the processing device to
provide an initiation option to a validation agent in response to the validation agent selecting a portion of a document retrieved from a reliable web source, the initiation option allowing the validation agent to initiate an automated validation procedure, and
in response to the validation agent selecting the initiation option, perform the automated validation procedure, wherein the automated validation procedure includes a) a comparing sub-step in which the portion of the document selected by the validation agent is compared with client information included in a certificate request, and b) a compliance sub-step in which it is determined whether or not a comparison, based on the comparing sub-step, complies with a validation guideline.

15. The system of claim 14, wherein the instructions further enable the processing device to present the portion of the document in a preview window of a User Interface (UI), wherein the initiation option is provided to the validation agent in response to the validation agent right-clicking on the portion of the document or inside the preview window.

16. The system of claim 14, wherein it is determined that the comparison complies with the validation guideline when a string literal of the portion of the document is an exact match with a string literal of the client information.

17. The system of claim 14, wherein the instructions further enable the processing device to:
obtain an annotation from the validation agent, the annotation related to an execution of the automated validation procedure; and
add the annotation to one of a) a digital certificate issued in response to the certificate request and b) a file associated with the execution of the automated validation procedure.

18. The system of claim 14, wherein the automated validation procedure further includes a qualifying sub-step in which it is determined whether or not the document qualifies as valid evidence with respect to the validation guideline.

19. A non-transitory computer-readable medium configured to store logical code having instructions that enable a processing device to:
provide an initiation option to a validation agent in response to the validation agent selecting a portion of a document retrieved from a reliable web source, the initiation option allowing the validation agent to initiate an automated validation procedure; and
in response to the validation agent selecting the initiation option, perform the automated validation procedure, wherein the automated validation procedure includes a) a comparing sub-step in which the portion of the document selected by the validation agent is compared with client information included in a certificate request, and b) a compliance sub-step in which it is determined whether or not a comparison, based on the comparing sub-step, complies with a validation guideline.

20. The non-transitory computer-readable medium of claim 19, wherein the instructions further enable the processing device to:
provide an output in a User Interface (UI) associated with the validation agent, the output related to results of the compliance sub-step;
highlight the portion of the document in an affirmative manner when it is determined that the comparison complies with the validation guideline; and
indicate non-compliance and providing resolution options when it is determined that the comparison does not comply with the validation guideline.
